(19) United States
(12) Patent Application Publication
(10) Pub. No.: US 2021/0250579 A1
(43) Pub. Date: Aug. 12, 2021

(54) INTRA-PICTURE PREDICTION IN VIDEO CODING SYSTEMS AND METHODS

(71) Applicant: REALNETWORKS, INC., Seattle, WA (US)

(72) Inventors: Weijia ZHU, Vancouver, WA (US); Chia-Yang TSAI, Seattle, WA (US)

(21) Appl. No.: 17/254,043

(22) PCT Filed: Jun. 20, 2018
(86) PCT No.: PCT/US2018/038557

§ 371 Date: Dec. 18, 2020

(51) Int. Cl. H04N 19/105; H04N 19/159; H04N 19/46; H04N 19/176

(52) U.S. Cl. CPC H04N 19/105; H04N 19/176; H04N 19/46; H04N 19/159

(57) ABSTRACT

Systems and methods for providing intra prediction for video encoders and decoders that utilize adaptive numbers of prediction modes dependent on the size of a coding block. Coding blocks that are smaller than N×N pixels (e.g., 16×16 pixels) may have a first number (e.g., 35) of possible intra prediction modes, and coding blocks that are equal to or larger than N×N pixels have a second larger number (e.g., 67) of possible modes. Systems and methods also provide for encoding and decoding the adaptive number of intra prediction modes in a manner that minimizes the data required to store and/or transmit the encoded information. A candidate mode list may be generated for each block that ignores candidate intra prediction modes of neighboring blocks that are not possible modes for the current block being processed, such that the video encoder and decoder can handle adaptive numbers of modes between various sizes of blocks.

### BACKGROUND

### Technical Field

The present disclosure generally relates to video processing, and more particularly, to intra prediction systems and methods.

### Description of the Related Art

The advent of digital multimedia such as digital images, speech/audio, graphics, and video have significantly improved various applications as well as opened up brand new applications due to relative ease by which it has enabled reliable storage, communication, transmission, and, search and access of content. Overall, the applications of digital multimedia have been many, encompassing a wide spectrum including entertainment, information, medicine, and security, and have benefited the society in numerous ways. Multimedia as captured by sensors such as cameras and microphones is often analog, and the process of digitization in the form of Pulse Coded Modulation (PCM) renders it digital. However, just after digitization, the amount of resulting data can be quite significant as is necessary to re-create the analog representation needed by speakers and/or TV display. Thus, efficient communication, storage or transmission of the large volume of digital multimedia content requires its compression from raw PCM form to a compressed representation. Thus, many techniques for compression of multimedia have been invented. Over the years, video compression techniques have grown very sophisticated to the point that they can often achieve high compression factors between 10 and 100 while retaining high psycho-visual quality, often similar to uncompressed digital video.

While tremendous progress has been made to date in the art and science of video compression (as exhibited by the plethora of standards bodies driven video coding standards such as MPEG-1, MPEG-2, H.263, MPEG-4 part2, MPEG-4 AVC/H.264, HEVC, AV1, MPEG-4 SVC and MVC, as well as industry driven proprietary standards such as Windows Media Video, RealVideo, On2 VP, and the like), the ever increasing appetite of consumers for even higher quality, higher definition, and now 3D (stereo) video, available for access whenever, wherever, has necessitated delivery via various means such as DVD/BD, over the air broadcast, cable/satellite, wired and mobile networks, to a range of client devices such as PCs/laptops, TVs, set top boxes, gaming consoles, portable media players/devices, smartphones, and wearable computing devices, fueling the desire for even higher levels of video compression. In the standards-body-driven standards, this is evidenced by the recently started effort by ISO MPEG in High Efficiency Video coding which is expected to combine new technology contributions and technology from a number of years of exploratory work on H.265 video compression by ITU-T standards committee.

All aforementioned standards employ a general intra/interframe predictive coding framework in order to reduce spatial and temporal redundancy in the encoded bitstream. The basic concept of interframe prediction is to remove the temporal dependencies between neighboring pictures by using block matching method. At the outset of an encoding process, each frame of the unencoded video sequence is grouped into one of three categories: I-type frames, P-type frames, and B-type frames. I-type frames are intra-coded. That is, only information from the frame itself is used to encode the picture and no inter-frame motion compensation techniques are used (although intra-frame motion compensation techniques may be applied).

The other two types of frames, P-type and B-type, are encoded using inter-frame motion compensation techniques. The difference between P-picture and B-picture is the temporal direction of the reference pictures used for motion compensation. P-type pictures utilize information from previous pictures in display order, whereas B-type pictures may utilize information from both previous and future pictures in display order.

For P-type and B-type frames, each frame is then divided into blocks of pixels, represented by coefficients of each pixel's luma and chrominance components, and one or more motion vectors are obtained for each block (because B-type pictures may utilize information from both a future and a past displayed frame, two motion vectors may be encoded for each block). A motion vector (MV) represents the spatial displacement from the position of the current block to the position of a similar block in another, previously encoded frame (which may be a past or future frame in display order), respectively referred to as a reference block and a reference frame. The difference between the reference block and the current block is calculated to generate a residual (also referred to as a “residual signal”). Therefore, for each block of an inter-coded frame, only the residuals and motion vectors need to be encoded rather than the entire contents of the block. By removing this kind of temporal redundancy between frames of a video sequence, the video sequence can be compressed.

To further compress the video data, after inter or intra frame prediction techniques have been applied, the coefficients of the residual signal are often transformed from the spatial domain to the frequency domain (e.g. using a discrete cosine transform (“DCT”) or a discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transform, the coefficients and motion vectors may be quantized and entropy encoded.

On the video decoder side, inversed quantization and inversed transforms are applied to recover the spatial residual signal. These are typical transform/quantization processes in all video compression standards. A reverse prediction process may then be performed in order to generate a recreated version of the original unencoded video sequence.

In past standards, the blocks used in coding were generally sixteen by sixteen pixels (referred to as macroblocks in many video coding standards). However, since the development of these standards, frame sizes have grown larger and many devices have gained the capability to display higher than “high definition” (or “HD”) frame sizes, such as 1920×1080 pixels. Thus it may be desirable to have larger blocks to efficiently encode the motion vectors for these frame size, e.g. 64×64 pixels. However, because of the corresponding increases in resolution, it also may be desirable to be able to perform motion prediction and transformation on a relatively small scale, e.g. 4×4 pixels.

### BRIEF SUMMARY

A video decoding method may be summarized as including receiving, by a video decoder, index information indicating an intra prediction mode to be used as an intra prediction mode of a current block; deriving, by the video decoder, at least a portion of a candidate mode list that includes one or more candidate intra prediction modes for the current block, wherein deriving the candidate mode list includes: determining whether each intra prediction mode for a plurality of neighboring blocks is one of a plurality of possible candidate intra prediction modes for the current block, the plurality of possible candidate intra prediction modes being dependent on a size of the current block; ignoring any intra prediction modes for the plurality of neighboring blocks that are not one of the possible candidate modes for the current block; for each of the intra prediction modes determined to be a possible candidate mode for the current block, if any, assigning the intra prediction mode to an index position in the candidate mode list according to an order determined by the respective position of each of the plurality of neighboring blocks relative to the current block; and assigning one or more remaining candidate modes to respective ones of the unassigned index positions of the candidate mode list according to a determined order; determining, by the video decoder, which one of the candidate modes in the derived candidate mode list is to be used as the intra prediction mode for the current block based on the received index information; and performing, by the video decoder, intra prediction on the current block to generate a predicted block that corresponds to the current block based on the determined intra prediction mode for the current block. Receiving index information may include receiving MPM flag information and at least one of MPM index information or remaining mode information. Receiving index information may include receiving a one bit MPM flag and at least one of MPM index information that includes one or two bits or remaining mode information that includes five or six bits.

The candidate mode list may include a most probable mode (MPM) sub-list and a non-MPM sub-list, the MPM sub-list including candidate intra prediction modes positioned at index positions 0 to 2 of the candidate mode list, and the non-MPM sub-list including candidate intra prediction modes positioned at index positions 3 to N−1 of the candidate mode list, wherein N may be the number of possible candidate modes for the current block, and wherein receiving index information may include receiving an MPM flag that indicates whether the candidate intra prediction mode is in the MPM sub-list or not. Receiving index information may include receiving a truncated unary code that specifies an index position in the MPM sub-list. Determining whether each intra prediction mode for a plurality of neighboring blocks is one of the possible candidate modes for the current block may include determining whether each intra prediction mode for three neighboring blocks is one of the possible candidate modes for the current block. The three neighboring blocks may include neighboring blocks that are each adjacent a top-left pixel of the current block.

The current block may include a first number of possible intra prediction modes, and at least one neighboring block may include a second number of possible intra prediction modes, the second number larger than the first number. If the current block has a size that is less than N×N pixels, the current block may have a first number of possible intra prediction modes that is less than a second number of possible intra prediction modes for blocks that have a size that is greater than or equal to N×N pixels. N may be equal to 16. Assigning one or more remaining candidate modes the unassigned index positions of the candidate mode list according to a determined order may include assigning one or more remaining candidate modes the unassigned index positions of the candidate mode list in an ascending order. The possible intra prediction modes for blocks in a first size range may include 35 intra prediction modes, and the possible intra prediction modes for blocks in a second size range may include 67 intra prediction modes. The 35 intra prediction modes may include a DC mode, a planar mode, and 33 directional modes, and the 67 intra prediction modes may include a DC mode, a planar mode, and 67 directional modes.

A video decoder may be summarized as including at least one nontransitory processor-readable storage medium that stores at least one of processor-executable instructions or data; and control circuitry communicatively coupled to the at least one nontransitory processor-readable storage medium, in operation, the control circuitry: receives index information indicating an intra prediction mode to be used as an intra prediction mode of a current block; derives at least a portion of a candidate mode list that includes one or more candidate intra prediction modes for the current block, wherein deriving the candidate mode list includes: determines whether each intra prediction mode for a plurality of neighboring blocks is one of a plurality of possible candidate intra prediction modes for the current block, the plurality of possible candidate intra prediction modes being dependent on a size of the current block; for each of the intra prediction modes determined to be a possible candidate mode for the current block, if any, assigns the intra prediction mode to an index position in the candidate mode list according to an order determined by the respective position of each of the plurality of neighboring blocks relative to the current block; and assigns one or more remaining candidate modes to respective ones of the unassigned index positions of the candidate mode list according to a determined order; determines which one of the candidate modes in the derived candidate mode list is to be used as the intra prediction mode for the current block based on the received index information; and performs intra prediction on the current block to generate a predicted block that corresponds to the current block based on the determined intra prediction mode for the current block.

The candidate mode list may include a most probable mode (MPM) sub-list and a non-MPM sub-list, the MPM sub-list including candidate intra prediction modes positioned at index positions 0 to 2 of the candidate mode list, and the non-MPM sub-list may include candidate intra prediction modes positioned at index positions 3 to N−1 of the candidate mode list, wherein N may be the number of possible candidate modes for the current block, and wherein the control circuitry may receive an MPM flag that indicates whether the candidate intra prediction mode is in the MPM sub-list or not. The index information may include a truncated unary code that specifies an index position in the MPM sub-list. The plurality of neighboring blocks may include three neighboring blocks. The three neighboring blocks may include neighboring blocks that are each adjacent a top-left pixel of the current block. The current block may include a first number of possible intra prediction modes, and at least one neighboring block may include a second number of possible intra prediction modes, the second number larger than the first number.

A video encoding method may be summarized as including receiving, by an encoder, an intra prediction mode to be used as the intra prediction mode of a current block; determining, by the video encoder, index information indicating the intra prediction mode, wherein determining index information includes: deriving, by the video encoder, at least a portion of a candidate mode list that includes one or more candidate intra prediction modes for the current block, wherein deriving the candidate mode list includes: determining whether each intra prediction mode for a plurality of neighboring blocks is one of a plurality of possible candidate intra prediction modes for the current block, the plurality of possible candidate intra prediction modes being dependent on a size of the current block; ignoring any intra prediction modes for the plurality of neighboring blocks that are not one of the possible candidate modes for the current block; for each of the intra prediction modes determined to be a possible candidate mode for the current block, if any, assigning the intra prediction mode to an index position in the candidate mode list according to an order determined by the respective position of each of the plurality of neighboring blocks relative to the current block; assigning one or more remaining candidate modes to respective ones of the unassigned index positions of the candidate mode list according to a determined order; and determining, by the video encoder, the index position of the one of the candidate modes in the derived candidate mode list that is equal to the received intra prediction mode for the current block.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 illustrates an exemplary video encoding/decoding system according to at least one embodiment.

FIG. 2 illustrates several components of an exemplary encoding device, in accordance with at least one embodiment.

FIG. 3 illustrates several components of an exemplary decoding device, in accordance with at least one embodiment.

FIG. 4 illustrates a block diagram of an exemplary video encoder in accordance with at least one embodiment.

FIG. 5 illustrates a block diagram of an exemplary video decoder in accordance with at least one embodiment.

FIG. 6 illustrates a block diagram of an example of a quad tree structure of process units in accordance with at least one embodiment.

FIG. 7 illustrates a diagram of angular prediction directions of intra prediction modes used for intra prediction in accordance with at least one embodiment.

FIG. 8 illustrates a first example of a current block and a plurality of neighboring blocks of varying size, in accordance with at least one embodiment.

FIG. 9 illustrates a second example of a current block and a plurality of neighboring blocks of varying size, in accordance with at least one embodiment.

FIG. 10 illustrates a high level flow diagram of a method of operating a video encoder to determine index information for an intra prediction mode of a current block, in accordance with at least one embodiment.

FIG. 11 illustrates a flow diagram of a method of operating a video encoder to derive at least a portion of a candidate intra prediction mode list for a current block, in accordance with at least one embodiment.

FIG. 12 illustrates a high level flow diagram of a method of operating a video decoder to decode an intra prediction mode for a current block, in accordance with at least one embodiment.

FIG. 13 illustrates a flow diagram of a method of operating a video decoder to derive at least a portion of a candidate intra prediction mode list for a current block, in accordance with at least one embodiment.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

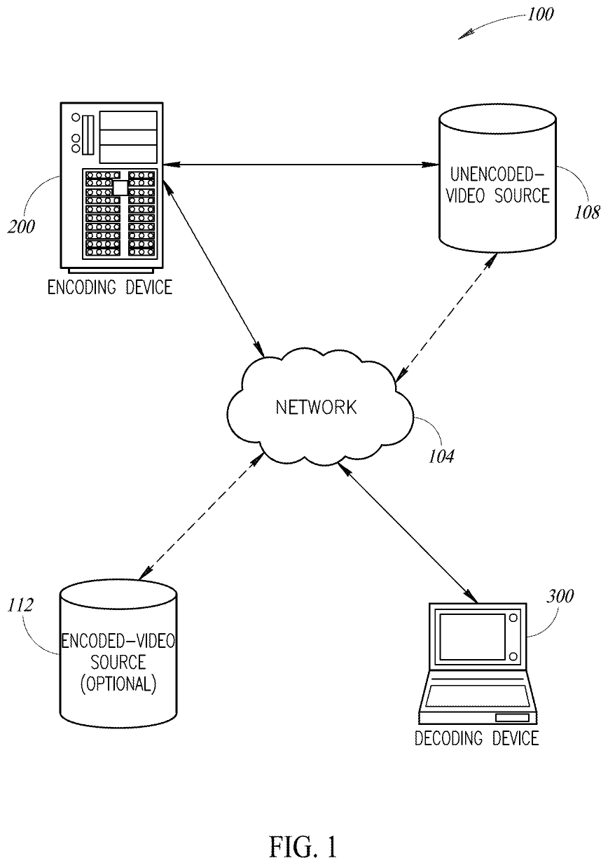

One or more implementations of the present disclosure are directed to systems and methods for providing intra prediction for video encoders and decoders that utilize adaptive numbers of prediction modes dependent on the size of the coding block (or “block”). As a non-limiting example, in at least some implementations, coding blocks that are smaller than N×N pixels (e.g., 16×16 pixels) may have a first number (e.g., 35) of possible intra prediction modes, and coding blocks that are equal to or larger than N×N pixels have a second larger number (e.g., 67) of possible intra prediction modes. Also provided herein are systems and methods for encoding and decoding the adaptive number of intra prediction modes that minimize the data required to store and/or transmit the encoded information. In at least some implementations, a candidate mode list (or “mode table”) is generated for each block that ignores or discards candidate intra prediction modes of neighboring blocks that are not possible intra prediction modes for the current block being processed. In this way, the video encoder and decoder can handle adaptive numbers of intra prediction modes between various sizes of coding blocks. The various features of the implementations of the present disclosure are discussed below with reference to FIGS. 1-13.

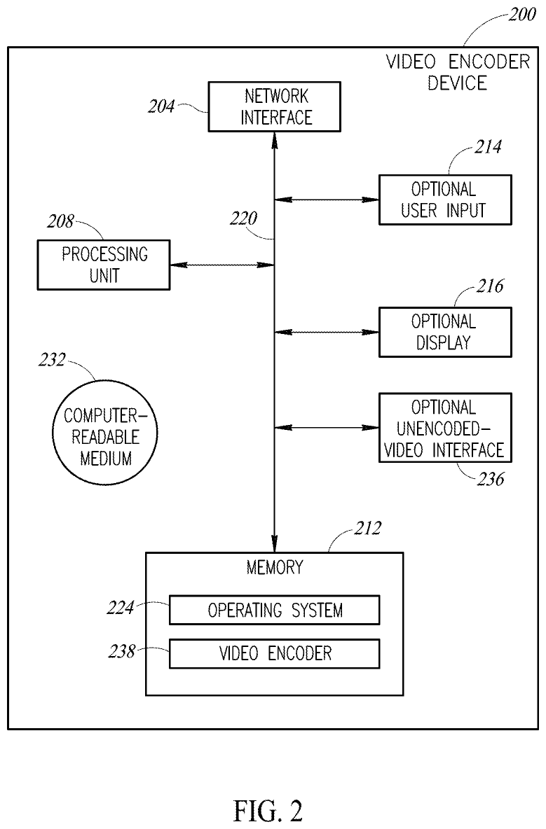

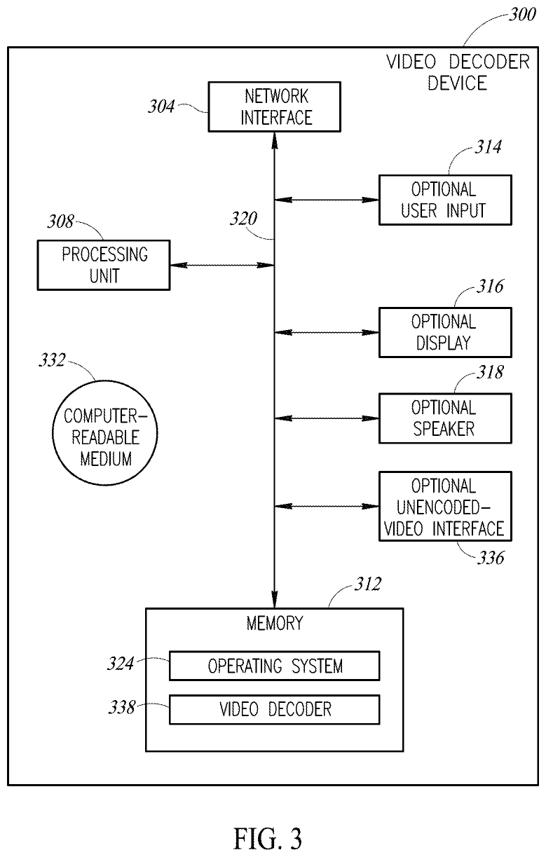

FIG. 1 illustrates an exemplary video encoding/decoding system 100 in accordance with at least one embodiment. Encoding device 200 (illustrated in FIG. 2 and described below) and decoding device 300 (illustrated in FIG. 3 and described below) are in data communication with a network 104. Decoding device 200 may be in data communication with unencoded video source 108, either through a direct data connection such as a storage area network (“SAN”), a high speed serial bus, and/or via other suitable communication technology, or via network 104 (as indicated by dashed lines in FIG. 1). Similarly, encoding device 300 may be in data communication with an optional encoded video source 112, either through a direct data connection, such as a storage area network (“SAN”), a high speed serial bus, and/or via other suitable communication technology, or via network 104 (as indicated by dashed lines in FIG. 1). In some embodiments, encoding device 200, decoding device 300, encoded-video source 112, and/or unencoded-video source 108 may comprise one or more replicated and/or distributed physical or logical devices. In many embodiments, there may be more encoding devices 200, decoding devices 300, unencoded-video sources 108, and/or encoded-video sources 112 than are illustrated.

In various embodiments, encoding device 200, may be a networked computing device generally capable of accepting requests over network 104, e.g., from decoding device 300, and providing responses accordingly. In various embodiments, decoding device 300 may be a networked computing device having a form factor such as a mobile phone; a watch, glass, or other wearable computing device; a dedicated media player; a computing tablet; a motor vehicle head unit; an audio-video on demand (AVOD) system; a dedicated media console; a gaming device, a “set-top box,” a digital video recorder, a television, or a general purpose computer. In various embodiments, network 104 may include the Internet, one or more local area networks (“LANs”), one or more wide area networks (“WANs”), cellular data networks, and/or other data networks. Network 104 may, at various points, be a wired and/or wireless network.

Referring to FIG. 2, several components of an exemplary encoding device 200 are illustrated. In some embodiments, an encoding device may include fewer or more components than those shown in FIG. 2. However, it is not necessary that all of these generally conventional components be shown in order to disclose an illustrative embodiment. As shown in FIG. 2, exemplary encoding device 200 includes a network interface 204 for connecting to a network, such as network 104. Exemplary encoding device 200 also includes a processing unit 208, a memory 212, an optional user input 214 (e.g. an alphanumeric keyboard, keypad, a mouse or other pointing device, a touchscreen, and/or a microphone), and an optional display 216, all interconnected along with the network interface 204 via a bus 220. The memory 212 generally comprises a RAM, a ROM, and/or a permanent mass storage device, such as a disk drive, flash memory, or the like.

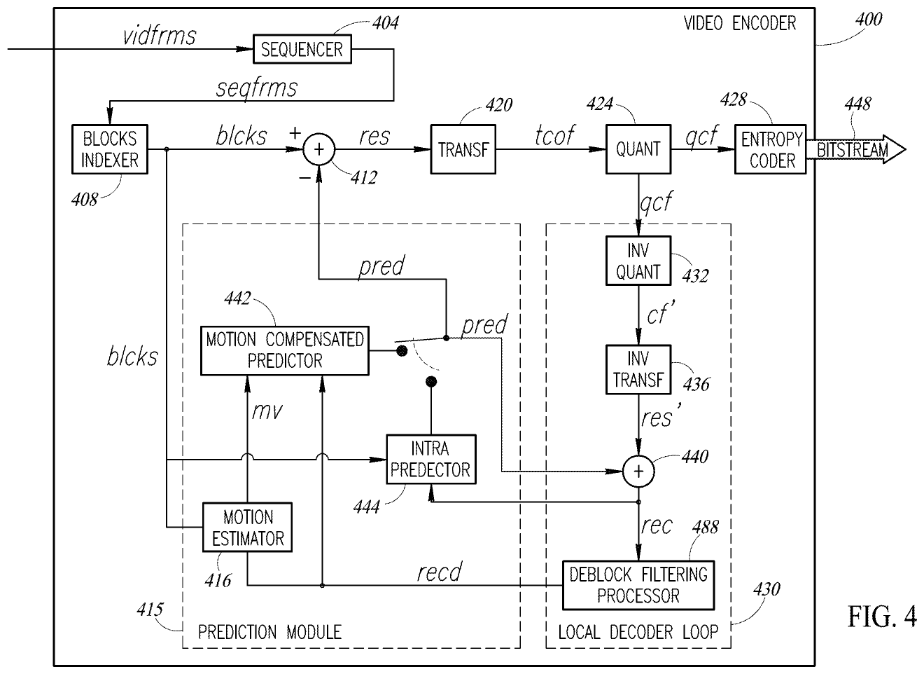

The memory 212 of exemplary encoding device 200 stores an operating system 224 as well as program code for a number of software services, such as a video encoder 238 (described below in reference to video encoder 400 of FIG. 4). Memory 212 may also store video data files (not shown) which may represent unencoded copies of audio/visual media works, such as, by way of examples, movies and/or television episodes. These and other software components may be loaded into memory 212 of encoding device 200 using a drive mechanism (not shown) associated with a non-transitory computer-readable medium 232, such as a floppy disc, tape, DVD/CD-ROM drive, memory card, or the like. Although an exemplary encoding device 200 has been described, an encoding device may be any of a great number of networked computing devices capable of communicating with network 104 and executing instructions for implementing video encoding software, such as exemplary video encoder 238 or video encoder 400 of FIG. 4.

In operation, the operating system 224 manages the hardware and other software resources of the encoding device 200 and provides common services for software applications, such as video encoder 238. For hardware functions such as network communications via network interface 204, receiving data via input 214, outputting data via display 216, and allocation of memory 212 for various software applications, such as video encoder 238, operating system 224 acts as an intermediary between software executing on the encoding device and the hardware.

In some embodiments, encoding device 200 may further comprise a specialized unencoded video interface 236 for communicating with unencoded-video source 108 (FIG. 1), such as a high speed serial bus, or the like. In some embodiments, encoding device 200 may communicate with unencoded-video source 108 via network interface 204. In other embodiments, unencoded-video source 108 may reside in memory 212 or computer readable medium 232.

Although an exemplary encoding device 200 has been described that generally conforms to conventional general purpose computing devices, an encoding device 200 may be any of a number of devices capable of encoding video, for example, a video recording device, a video co-processor and/or accelerator, a personal computer, a game console, a set-top box, a handheld or wearable computing device, a smart phone, or any other suitable device.

Encoding device 200 may, by way of example, be operated in furtherance of an on-demand media service (not shown). In at least one exemplary embodiment, the on-demand media service may be operating encoding device 200 in furtherance of an online on-demand media store providing digital copies of media works, such as video content, to users on a per-work and/or subscription basis. The on-demand media service may obtain digital copies of such media works from unencoded video source 108.

Referring to FIG. 3, several components of an exemplary decoding device 300 are illustrated. In some embodiments, a decoding device may include fewer or more components than those shown in FIG. 3. However, it is not necessary that all of these generally conventional components be shown in order to disclose an illustrative embodiment. As shown in FIG. 3, exemplary decoding device 300 includes a network interface 304 for connecting to a network, such as network 104. Exemplary decoding device 300 also includes a processing unit 308, a memory 312, an optional user input 314 (e.g. an alphanumeric keyboard, keypad, a mouse or other pointing device, a touchscreen, and/or a microphone), an optional display 316, and an optional speaker 318, all interconnected along with the network interface 304 via a bus 320. The memory 312 generally comprises a RAM, a ROM, and a permanent mass storage device, such as a disk drive, flash memory, or the like.

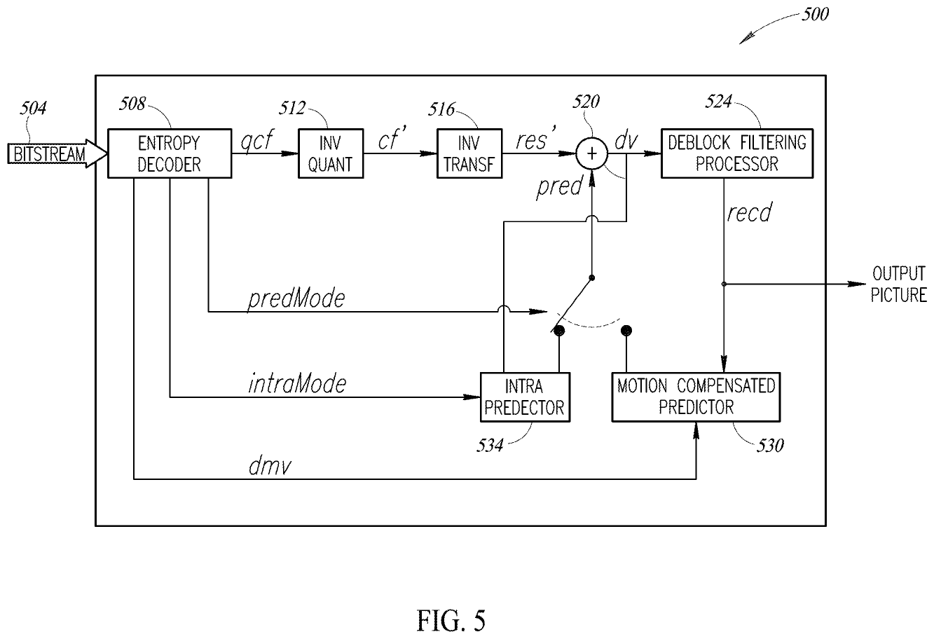

The memory 312 of exemplary decoding device 300 may store an operating system 324 as well as program code for a number of software services, such as video decoder 338 (described below in reference to video decoder 500 of FIG. 5). Memory 312 may also store video data files (not shown) which may represent encoded copies of audio/visual media works, such as, by way of example, movies and/or television episodes. These and other software components may be loaded into memory 312 of decoding device 300 using a drive mechanism (not shown) associated with a non-transitory computer-readable medium 332, such as a floppy disc, tape, DVD/CD-ROM drive, memory card, or the like. Although an exemplary decoding device 300 has been described, a decoding device may be any of a great number of networked computing devices capable of communicating with a network, such as network 120, and executing instructions for implementing video decoding software, such as video decoder 338.

In operation, the operating system 324 manages the hardware and other software resources of the decoding device 300 and provides common services for software applications, such as video decoder 338. For hardware functions such as network communications via network interface 304, receiving data via input 314, outputting data via display 316 and/or optional speaker 318, and allocation of memory 312, operating system 324 acts as an intermediary between software executing on the encoding device and the hardware.

In some embodiments, the decoding device 300 may further comprise an optional encoded video interface 336, e.g., for communicating with encoded-video source 116, such as a high speed serial bus, or the like. In some embodiments, decoding device 300 may communicate with an encoded-video source, such as encoded video source 116, via network interface 304. In other embodiments, encoded-video source 116 may reside in memory 312 or computer readable medium 332.

Although an exemplary decoding device 300 has been described that generally conforms to conventional general purpose computing devices, an decoding device 300 may be any of a great number of devices capable of decoding video, for example, a video recording device, a video co-processor and/or accelerator, a personal computer, a game console, a set-top box, a handheld or wearable computing device, a smart phone, or any other suitable device.

Decoding device 300 may, by way of example, be operated in furtherance of an on-demand media service. In at least one exemplary embodiment, the on-demand media service may provide digital copies of media works, such as video content, to a user operating decoding device 300 on a per-work and/or subscription basis. The decoding device may obtain digital copies of such media works from unencoded video source 108 via, for example, encoding device 200 via network 104.

FIG. 4 shows a general functional block diagram of software implemented video encoder 400 (hereafter “encoder 400”) employing residual transformation techniques in accordance with at least one embodiment. The video encoder 400 may be similar or identical to the video encoder 238 of the encoding device 200 shown in FIG. 2. One or more unencoded video frames (vidfrms) of a video sequence in display order may be provided to sequencer 404.

Sequencer 404 may assign a predictive-coding picture-type (e.g. I, P, or B) to each unencoded video frame and reorder the sequence of frames, or groups of frames from the sequence of frames, into a coding order for motion prediction purposes (e.g. I-type frames followed by P-type frames, followed by B-type frames). The sequenced unencoded video frames (seqfrms) may then be input in coding order to blocks indexer 408.

For each of the sequenced unencoded video frames (seqfrms), blocks indexer 408 may determine a largest coding block (“LCB”) size for the current frame (e.g. sixty-four by sixty-four pixels) and divide the unencoded frame into an array of coding blocks (blcks). Individual coding blocks within a given frame may vary in size, e.g. from four by four pixels up to the LCB size for the current frame.

Each coding block may then be input one at a time to differencer 412 and may be differenced with corresponding prediction signal blocks (pred) generated in a prediction module 415 from previously encoded coding blocks. To generate the prediction blocks (pred), coding blocks (blcks) are also provided to an intra-predictor 444 and a motion estimator 416 of the prediction module 415. After differencing at differencer 412, a resulting residual block (res) may be forward-transformed to a frequency-domain representation by transformer 420, resulting in a block of transform coefficients (tcoj). The block of transform coefficients (tcoj) may then be sent to a quantizer 424 resulting in a block of quantized coefficients (qcj) that may then be sent both to an entropy coder 428 and to a local decoder loop 430.

For intra-coded coding blocks, intra-predictor 444 provides a prediction signal representing a previously coded area of the same frame as the current coding block. For an inter-coded coding block, motion compensated predictor 442 provides a prediction signal representing a previously coded area of a different frame from the current coding block.

At the beginning of local decoding loop 430, inverse quantizer 432 may de-quantize the block of transform coefficients (cf) and pass them to inverse transformer 436 to generate a de-quantized residual block (res′). At adder 440, a prediction block (pred) from motion compensated predictor 442 or intra predictor 444 may be added to the de-quantized residual block (res′) to generate a locally decoded block (rec). Locally decoded block (rec) may then be sent to a frame assembler and deblock filter processor 488, which reduces blockiness and assembles a recovered frame (recd), which may be used as the reference frame for motion estimator 416 and motion compensated predictor 442.

Entropy coder 428 encodes the quantized transform coefficients (qcf), differential motion vectors (dmv), and other data, generating an encoded video bit-stream 448. For each frame of the unencoded video sequence, encoded video bit-stream 448 may include encoded picture data (e.g. the encoded quantized transform coefficients (qcj) and differential motion vectors (dmv)) and an encoded frame header (e.g. syntax information such as the LCB size for the current frame).

FIG. 5 shows a general functional block diagram of a corresponding video decoder 500 (hereafter “decoder 500”) that implements inverse residual transformation techniques in accordance with at least one embodiment and that is suitable for use with a decoding device, such as decoding device 300. Decoder 500 may work similarly to the local decoding loop 430 of encoder 400 discussed above.

Specifically, an encoded video bit-stream 504 to be decoded may be provided to an entropy decoder 508, which may decode blocks of quantized coefficients (qcj), differential motion vectors (dmv), accompanying message data packets (msg-data), and other data, including the prediction mode (intra or inter). The quantized coefficient blocks (qcj) may then be reorganized by an inverse quantizer 512, resulting in recovered transform coefficient blocks (cf). Recovered transform coefficient blocks (cf) may then be inverse transformed out of the frequency-domain by an inverse transformer 516, resulting in decoded residual blocks (res′).

When the prediction mode for a current block is the inter prediction mode, an adder 520 may add motion compensated prediction blocks (psb) obtained by using corresponding motion vectors (dmv) from a motion compensated predictor 528.

When the prediction mode for a current block is the intra prediction mode, a predicted block may be constructed on the basis of pixel information of a current picture. At this time, the intra predictor 534 may determine an intra prediction mode of the current block and may perform the prediction on the basis of the determined intra prediction mode. Here, when intra prediction mode-relevant information received from the video encoder is confirmed, the intra prediction mode may be induced to correspond to the intra prediction mode-relevant information.

The resulting decoded video (dv) may be deblock-filtered in a frame assembler and deblock filtering processor 524. Blocks (recd) at the output of frame assembler and deblock filtering processor 524 form a reconstructed frame of the video sequence, which may be output from the video decoder 500 and also may be used as the reference frame for a motion-compensated predictor 528 for decoding subsequent coding blocks.

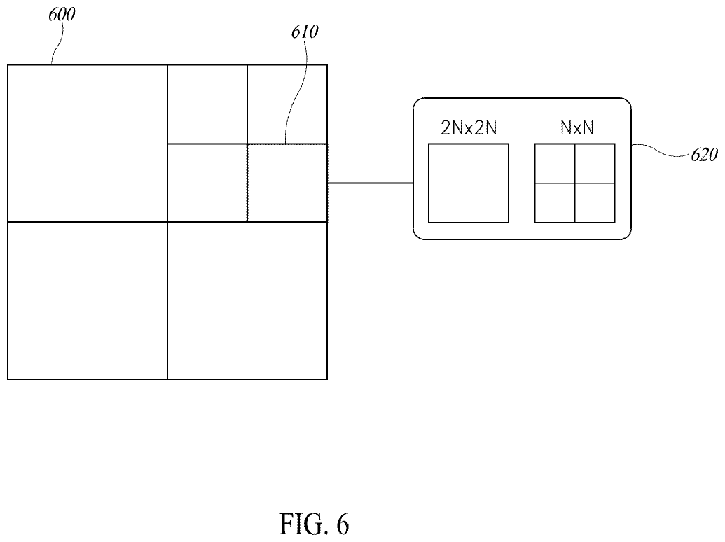

FIG. 6 illustrates a block diagram of an example of a quad tree structure of coding units or blocks according to one non-limiting illustrated implementation. A coding block that is partitioned on the basis of a quad tree structure may be referred to as a coding tree block. One coding tree block may not be additionally partitioned. In such cases the coding tree block may itself be one coding block or unit upon which the video encoder may perform an encoding operation. The coding block may have various sizes, such as 64×64 pixels, 32×32 pixels, 16×16 pixels, 8×8 pixels, 4×4 pixels, etc. A coding block that has the largest possible size may be referred to as a largest coding block (LCB), and a coding block that has the smallest possible size may be referred to as a smallest coding block (SCB).

In FIG. 6, a coding tree block 600 is shown as having a hierarchical structure that includes smaller coding blocks 610 obtained by partitioning the coding tree block. The size information, the partition depth information, and the partition flag information of a coding tree block may be transmitted from the video encoder to a video decoder in a state where they are included in a sequence parameter set in a bit stream, for example.

The coding block 610 may be used as one prediction block or may be partitioned into a plurality of prediction blocks. In the case of intra prediction shown at 620, a partitioning mode of a coding block and/or a prediction block may be size 2N×2N or N×N, for example, where N is an integer (e.g., 4, 8, 16, 32). In the case of intra prediction shown at 620, a partitioning mode of a coding block and/or a prediction block may be size N×M, for example, where N is an integer (e.g., 4, 8, 16, 32) and M is the same or a different integer (e.g., 4, 8, 16, 32). For intra prediction mode, the prediction module may perform a prediction on the basis of pixel information in a reconstructed region of a current picture and may construct a predicted block of the current block. For example, the prediction module may predict pixel values in the current block using pixels in reconstructed blocks located on the upper side, the left side, the left-upper side, and/or the right-upper side of the current block.

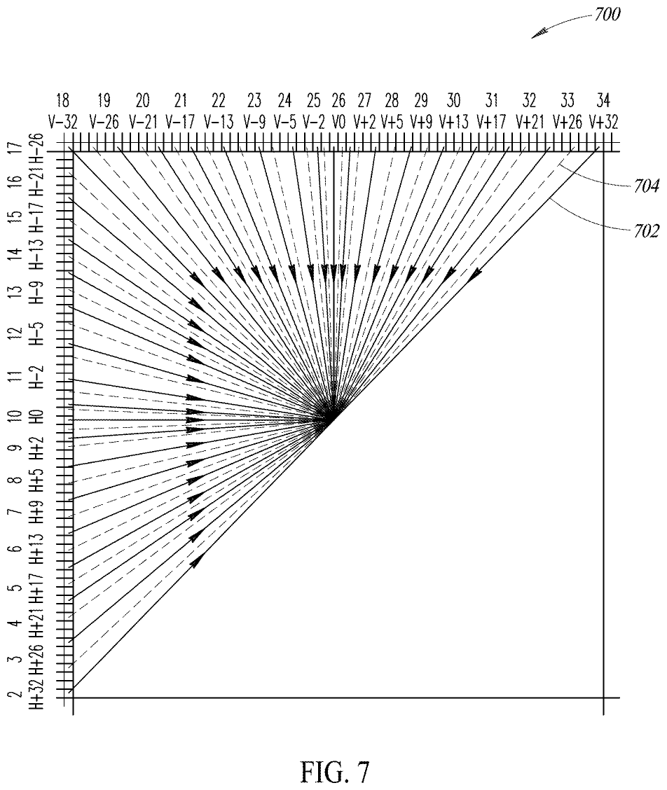

FIG. 7 is a diagram 700 that schematically illustrates examples of prediction directions of intra prediction modes used for intra prediction. The intra prediction process may be performed on the basis of the intra prediction mode of the current block under consideration. The respective intra prediction modes used for the intra prediction process may have a predetermined angle and/or a prediction direction and a predetermined prediction mode number may be allocated to each intra prediction mode. Examples of the intra prediction modes may include angular prediction modes shown in FIG. 7, a DC mode, and a planar mode.

In the DC mode, a fixed value may be used as a predicted value of pixels in the current block. For example, the fixed value may be derived by averaging the neighboring pixel values of the current block. In the planar mode, predicted values of prediction target pixels located in the current block may be derived through a predetermined calculation on the basis of the pixel values of plural neighboring pixels of the current block. Plural pixels used to predict the prediction target pixels may be determined differently depending on the positions of the prediction target pixels. In the angular modes, the prediction may be performed depending on the angle and/or the direction determined in advance for each mode.

As discussed briefly above, the systems and methods herein may utilize an adaptive number of angular modes dependent on the size of the current block since smaller blocks may not benefit from a larger number of angular prediction modes. In the example shown in FIG. 7, smaller blocks (e.g., blocks less than 16×16 pixels in size) may utilize the 33 angular modes 702 shown in solid lines, whereas larger blocks (e.g., blocks greater than or equal to 16×16 pixels in size) may utilize the 33 angular modes 702 shown in solid lines and the 32 angular modes 704 shown in dashed lines that interlaced with the angular modes 702. Thus, in the example, provided smaller blocks have 33 possible angular intra prediction modes and larger blocks have 65 possible angular intra prediction modes.

In the example of FIG. 7, the prediction mode number allocated to the planar mode may be 0 and the prediction mode number allocated to the DC mode may be 1. The prediction mode numbers allocated to the angular modes 702 and 704 may be 2-66, wherein the 33 angular modes 702 are numbered as prediction mode numbers 2, 4, 6, 8, . . . , 66, and the 32 angular modes 704 are numbered as prediction mode numbers 3, 5, 7, 9, . . . , 65. Thus, in this example, smaller blocks may have 35 possible prediction modes (i.e., modes 0, 1, 2, 4, 6, 8, . . . , 66), and larger blocks may have 67 possible prediction modes (i.e., modes 0-66).

Generally, after determining an intra prediction mode (e.g., via sum of absolute differences, mean square error), the video encoder may encode information on the determined intra prediction mode and may transmit the encoded information to the video decoder. The information concerning the intra prediction mode for a particular block may be transmitted as a value itself (e.g., 2, 32, 65) indicating the prediction mode, or a method of transmitting intra prediction mode information on the basis of the mode number predicted for the intra prediction mode may be used to significantly improve transmission efficiency. In the description below, a prediction mode used as a predicted value of an intra prediction mode for a current block may be referred to as a most probable mode (MPM).

In operation, the video encoder may derive or construct at least a portion of a candidate intra prediction mode list that may include an MPM sub-list and a remaining or non-MPM sub-list. The MPM sub-list may include a plurality of MPM candidates. In other words, the video encoder may derive a plurality of MPM candidates on the basis of the intra prediction modes of a plurality of neighboring blocks adjacent to the current block and may allocate the MPM candidates to the MPM sub-list. Although the MPM sub-list and the non MPM sub-list are referred to herein as “sub-lists,” it should be appreciated that they may each be separate lists that are each made up of some of the possible intra prediction modes for a current block.

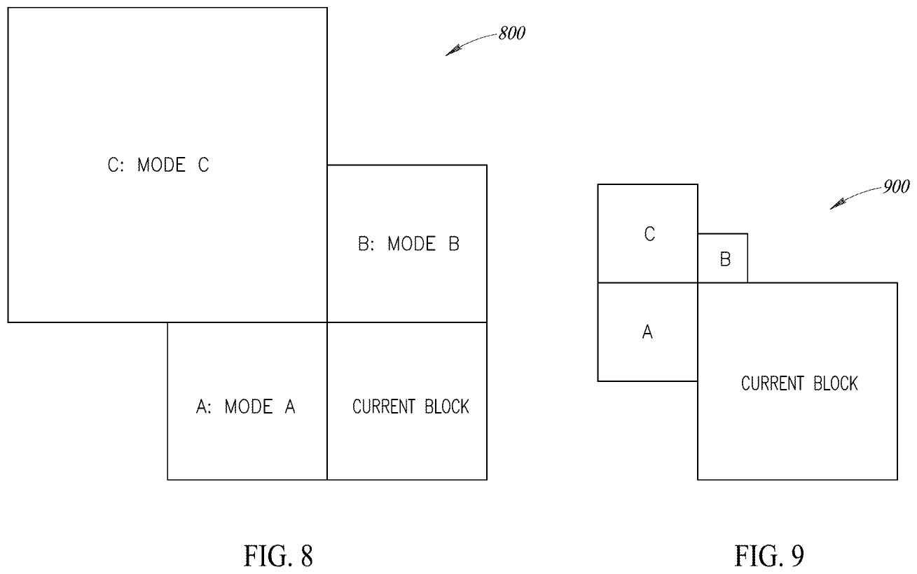

FIG. 8 shows an example diagram 800 of a current block that has three neighboring blocks designated block A, block B, and block C. Each of neighboring blocks A, B and C are adjacent a top-left pixel of the current block. In this example, the neighboring blocks A and B are the same size as the current block (e.g., 8×8 pixels), and neighboring block C is a larger block (e.g., 16×16 pixels). In the example discussed above, the current block, block A, and block B may have 35 possible intra prediction modes, whereas the neighboring block C may have 67 possible intra prediction modes. That is, the possible intra prediction modes for the current block, block A (“mode A”), and block B (“mode B”) are modes 0, 1, 2, 4, 6, 8, . . . , 66, and the possible intra prediction modes for block C (“mode C”) are modes 0-66.

FIG. 9 shows another example diagram 900 of a larger current block that has three smaller neighboring blocks designated block A, block B, and block C. Each of neighboring blocks A, B and C are adjacent a top-left pixel of the current block. In this example, the neighboring blocks A, B and C are all smaller in size than the current block. Continuing with the example discussed above, the block A, block B and block C may have 35 possible intra prediction modes, whereas the current block C may have 67 possible intra prediction modes. That is, the possible intra prediction modes for block A, block B, and block C are modes 0, 1, 2, 4, 6, 8, . . . , 66, and the possible intra prediction modes for the current block are modes 0-66.

Index values may be allocated to the plurality of MPM candidates that make up the MPM sub-list. For example, an index value of 0 may be allocated to the first MPM candidate, an index value of 1 may be allocated to the second MPM candidate, and an index value of n−1 may be allocated to an nth MPM candidate in the candidate list. Thus, relatively small index values may be used to allocate MPM candidates that are positioned relatively early in the candidate list.

In at least some implementations, the number of MPM candidates in the MPM sub-list is fixed. For example, the number of MPM candidates constituting the MPM sub-list may be fixed to two or three candidates.

When the number of MPM candidates included in the MPM sub-list is fixed, the number of MPM candidates derived to correspond to the neighboring blocks may be smaller than the fixed number. For example, the number of MPM candidates included in the MPM sub-list may be fixed to three and three neighboring blocks may be used to induce the MPM candidates. If the intra prediction modes of two (or all three) of the neighboring blocks are equal to each other, the number of MPM candidates induced to correspond to the neighboring blocks may be 1 or 2. In this case, the video encoder may determine one or two additional MPM candidates and may allocate the determined additional MPM candidate(s) to the MPM sub-list. The additionally-induced MPM candidate may be selected from the intra prediction modes other than the MPM candidates induced to correspond to the neighboring blocks.

As another example, a current block may be a smaller block that has one or more neighboring blocks that are larger in size and therefor have possible intra prediction modes that are not possible for the current (smaller) block. For example, the current block may have possible intra prediction modes 0, 1, 2, 4, 6, 8, . . . , 66, and one or more larger neighboring blocks may have possible intra prediction modes 0-66. In such cases, the video encoder may discard or ignore intra prediction modes of neighboring blocks that are not possible intra prediction modes for the current block. As discussed above, in such cases the video encoder may determine additional MPM candidates and may allocate the determined additional MPM candidate(s) to the MPM sub-list. The additionally-induced MPM candidate may be selected from the intra prediction modes other than the MPM candidates induced to correspond to the neighboring blocks.

The video encoder may generate information concerning the intra prediction modes on the basis of the MPM sub-list and may encode and transmit the information to a video decoder. In particular, the video encoder may generate MPM flag information by determining whether an MPM candidate mode to be used as the intra prediction mode for the current block is present in the plurality of MPM candidates constituting the MPM sub-list.

When an MPM candidate to be used as the intra prediction mode for the current block is present in the MPM sub-list, the video encoder may generate index information indicating an MPM candidate to be used as the intra prediction mode of the current block out of the plurality of MPM candidates constituting the MPM candidate list. For example, the index information may indicate an index value allocated to the MPM candidate to be used as the intra prediction mode of the current block. In some implementations, a truncated unary code may be used, wherein the binary values of 0, 10, and 11 may be used to represent the three index positions 0, 1, and 2, respectively, of the MPM sub-list.

When an MPM candidate to be used as the intra prediction mode for the current block is not present in the MPM sub-list, the video encoder may generate index information indicating a location in the remaining or non-MPM sub-list of the candidate modes list corresponding to the intra prediction mode of the current block. In the example above, smaller blocks may have a non-MPM sub-list that includes 32 possible intra prediction modes (i.e., 35 total modes less 3 modes in the MPM sub-list). Thus, for smaller blocks, 5 bits may be used to represent the index information for the current block when the intra prediction mode is not in the MPM sub-list. Similarly, larger blocks may have a non-MPM sub-list that includes 64 possible intra prediction modes (i.e., 67 total modes less 3 modes in the MPM sub-list). Thus, for larger blocks, 6 bits may be used to represent the index information for the current block when the intra prediction mode is not in the MPM sub-list.

The following examples are provided to further explain the determination of the MPM sub-list and the non-MPM sub-list of the candidate modes list. Referring back to FIG. 8, assume the current block is a smaller block (e.g., less than 16×16 pixels) that has a determined intra prediction mode of M. Recall that the possible intra prediction modes for the current block, neighboring block A (“mode A”), and neighboring block B (“mode B”) are modes 0, 1, 2, 4, 6, 8, . . . , 66 (i.e., 35 modes), and the possible intra prediction modes for neighboring block C (“mode C”) are modes 0-66 (i.e., 67 modes).

As a first example, the three neighboring blocks A, B, and C may have intra prediction modes 0, 4 and 5, respectively. Since the block C has a mode 5 that is not a possible mode for the current block, the mode 5 is discarded, and the MPM sub-list is made up of the intra prediction values for the neighboring blocks A and B and one of the remaining possible modes. That is, the MPM sub-list would be [0, 4, 1], with 1 being a first one of the remaining modes from the possible modes of 0, 1, 2, 4, 6, 8, . . . , 66. In this example, the non-MPM list would be [2, 6, 8, 10, . . . , 66]. It is noted that mode 4 is removed since it already appears in the MPM sub-list.

In this example, if the determined intra prediction mode for the current block is 0, 4, or 1, the MPM flag would be set and the video encoder would generate index information to identify the index position of the intra prediction code. As an example using truncated unary codes, if the determined intra prediction mode is 0, the video encoder would generate a binary index value of 0 (i.e., index position 0), if the determined intra prediction mode is 4, the video encoder would generate a binary index value of 10 (i.e., index position 1), and if the determined intra prediction mode is 1, the video encoder would generate a binary index value of 11 (i.e., index position 2).

If the determined intra prediction mode for the current block is not 0, 4 or 1, then the MPM flag would not be set and the intra prediction mode would be indicated by the index position in the non-MPM list that corresponds to the determined intra prediction mode. For example, if the non-MPM sub-list is [2, 6, 8, 10, . . . , 66], and the determined intra prediction mode is 10, then the index information would indicate that the determined intra prediction mode for the current block is index position 3 (e.g., binary 00011) of the non-MPM sub-list, which is the index position of mode 10 in the non-MPM sub-list.

As another example, the three neighboring blocks A, B, and C, may have intra prediction modes 2, 2 and 7, respectively. Since the neighboring block C has a mode 7 that is not a possible mode for the current block, the mode 7 is discarded. Further, since blocks A and B have the same mode (i.e., mode 2), the MPM sub-list is made up of only one intra prediction value, mode 2, of the neighboring blocks and two of the remaining possible modes. That is, the MPM sub-list would be [2, 0, 1], with 0 and 1 being the first two of the remaining modes. In this example, the non-MPM list would be [4, 6, 8, 10, . . . , 66], which are the ordered remaining possible modes for the current block.

In this example, if the determined intra prediction mode for the current block is 2, 0, or 1, the MPM flag would be set and the video encoder would generate index information to identify the index position of the intra prediction code. As an example using truncated unary codes, if the determined intra prediction mode is 2, the video encoder would generate a binary index value of 0 (i.e., index position 0), if the determined intra prediction mode is 0, the video encoder would generate a binary index value of 10 (i.e., index position 1), and if the determined intra prediction mode is 1, the video encoder would generate a binary index value of 11 (i.e., index position 2).

If the determined intra prediction mode for the current block is not 2, 0, or 1, then the MPM flag would not be set and the intra prediction mode would be indicated by the index position in the non-MPM list that corresponds to the determined intra prediction mode. For example, if the non-MPM sub-list is [4, 6, 8, 10, . . . , 66], and the determined intra prediction mode is 6, then the index information would indicate that the determined intra prediction mode for the current block is index position 2 (e.g., binary 00010) of the non-MPM sub-list, which is the index position of mode 6 in the non-MPM sub-list.

The video decoder may receive intra prediction mode information from the video encoder and may decode the information. The intra prediction mode information received from the video encoder may include MPM flag information (e.g., one bit), MPM index information (e.g., one or two bits), and/or remaining mode information (e.g., five or six bits). The video decoder may only receive one of the MPM index information and the remaining mode information dependent on whether the MPM flag is set. The video decoder may derive MPM candidates using the same method as the video encoder and may similarly construct the MPM candidate list.

The video decoder may determine whether an MPM candidate to be used as the intra prediction mode for the current block is present in the MPM sub-list by reviewing the MPM flag information received from the video encoder described above.

When an MPM candidate to be used as the intra prediction mode of the current block is present in the MPM sub-list, the video decoder may determine the MPM candidate indicated by the MPM index information to be the intra prediction mode of the current block. When an MPM candidate to be used as the intra prediction mode of the current block is not present in the MPM sub-list, the video decoder may derive the intra prediction mode of the current block on the basis of remaining mode information received from the video encoder. Using the decoded intra prediction mode information from the video encoder, the video decoder may construct a predicted block corresponding to the current block by performing the intra prediction on the current block on the basis of the determined intra prediction mode of the current block.

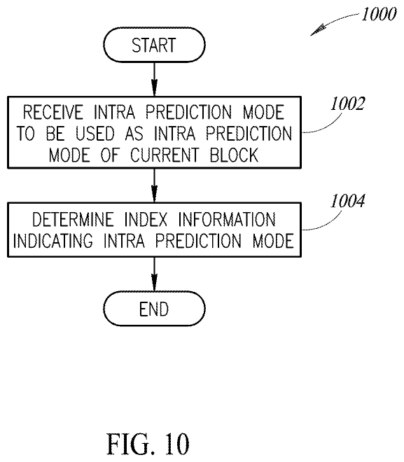

FIG. 10 illustrates a high level flow diagram of a method 1000 of operating a video encoder to determine intra prediction mode index information for a current block of a video frame. The method 1000 may be performed by the video encoder devices 200 and 400 discussed above, for example.

The method 1000 begins, after a start block, at 1002 wherein the video encoder receives an intra prediction mode to be used as the intra prediction mode of a current block. As an example, the intra prediction mode may be determined by the video encoder using one or more distance based objective quality metrics, such as mean-squared error (MSE) or sum of absolute differences (SAD). As noted above, in at least some implementations smaller blocks may have fewer possible intra prediction modes than larger blocks.

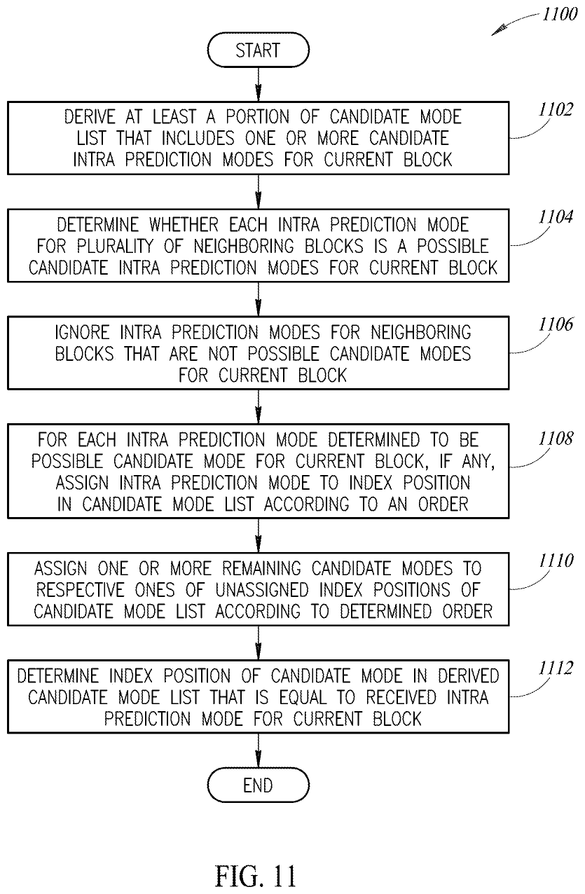

At 1004, the video encoder determines index information indicating the intra prediction mode for the current block. For example, the video encoder may determine whether to set an MPM flag, and may determine an index position in the MPM sub-list or the remaining non-MPM sub-list dependent on whether the intra prediction mode for the current block is in the MPM sub-list or not. An example method 1100 for determining the index information indicating the intra prediction mode for the current block provided in FIG. 11, discussed below.

FIG. 11 illustrates a flow diagram of a method 1100 of operating a video encoder to determine index information indicating the intra prediction mode for a current block. The method 1100 may be performed by the video encoder devices 200 and 400 discussed above, for example. The determined index information may be subsequently used by a video decoder to identify the intra prediction mode for the current block.

At 1102, the video encoder derives at least a portion of a candidate mode list that includes one or more candidate intra prediction modes for the current block. For example, the video encoder may derive an MPM sub-list or a remaining or non-MPM sub-list of the candidate mode list. Deriving the candidate mode list is discussed below with reference to acts 1104 to 1112 of the method 1100.

At 1104, the video encoder determines whether each intra prediction mode for a plurality (e.g., two, three, four) of neighboring blocks is one of a plurality of possible candidate intra prediction modes for the current block. The plurality of possible candidate intra prediction modes may be dependent on a size of the current block. As noted above, in at least some implementations smaller blocks (e.g., less than 16×16 pixels) may have a smaller number (e.g., 35) of possible intra prediction modes than larger blocks, which may have a larger number (e.g., 67) of intra prediction modes.

At 1106, the video encoder ignores any intra prediction modes for the plurality of neighboring blocks that are not one of the possible candidate modes for the current block. For example, if a larger neighboring block has an intra prediction mode that is not a possible intra prediction mode for the smaller current block, the video encoder ignores or discards that intra prediction mode.

At 1108, for each of the intra prediction modes determined to be a possible candidate mode for the current block, if any, the video encoder assigns the intra prediction mode to an index position in the candidate mode list according to an order determined by the respective position of each of the plurality of neighboring blocks relative to the current block. For instance, the video encoder may utilize three neighboring blocks, namely, three neighboring blocks that are adjacent the top-left pixel of the current block. The video encoder may order the three neighboring blocks in the MPM sub-list according to a determined order that is also known by the video decoder. As an non-limiting example, the video encoder may order the neighboring block to the left of the current block first, the neighboring block positioned above the current block second, and the neighboring block positioned diagonal to the current block third.

At 1110, the video encoder assigns one or more remaining candidate modes to respective ones of the unassigned index positions of the candidate mode list according to a determined order. For example, if the intra prediction modes of the three neighboring blocks fill the MPM sub-list, the video encoder may assign the remaining candidate modes the unassigned index positions in the non-MPM list in an ascending order, omitting any intra prediction modes that are already in the MPM sub-list.

At 1112, the video encoder determines the index position of the one of the candidate modes in the derived candidate mode list that is equal to the received intra prediction mode for the current block. The index position may be in the MPM sub-list or the non-MPM sub-list, as discussed above.

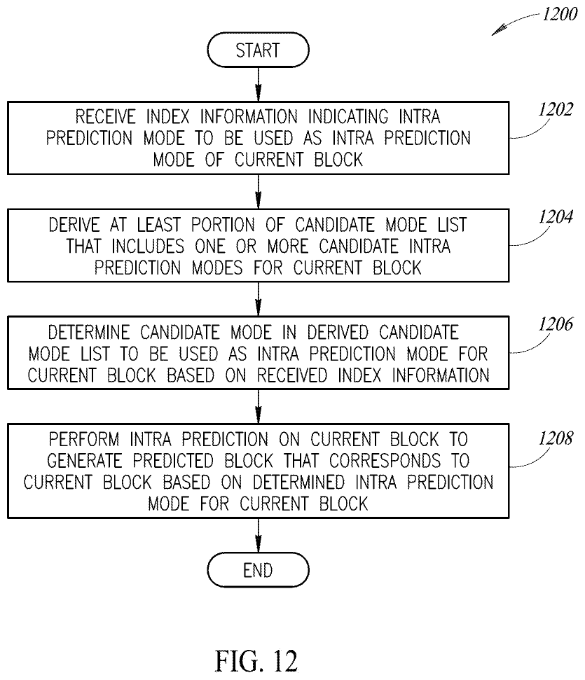

FIG. 12 illustrates a high level flow diagram of a method 1200 of operating a video decoder to decode an intra prediction mode for a current block. The method 1200 may be performed by the video decoder devices 300 and 500 discussed above, for example.

At 1202, the video decoder receives index information indicating an intra prediction mode to be used as an intra prediction mode of a current block. The received index information may include MPM flag information and at least one of MPM index information or remaining mode (non-MPM) information. In at least some implementations, the received index information may include a one bit MPM flag and at least one of MPM index information that includes one or two bits (e.g., truncated unary code) or remaining mode information that comprises five or six bits (e.g., representing 32 or 64 intra prediction modes).

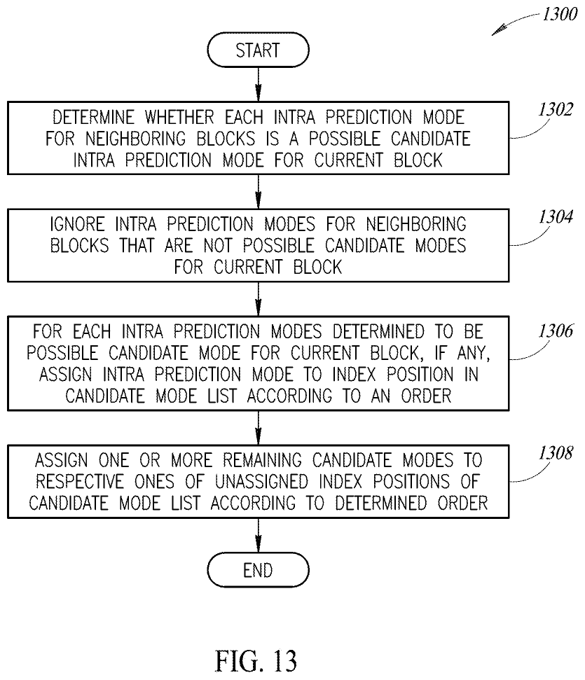

At 1204, the video decoder derives at least a portion of a candidate mode list that includes one or more candidate intra prediction modes for the current block. Deriving the candidate mode list is discussed further below with reference to the method 1300 of FIG. 13.

At 1206, the video decoder determines which one of the candidate modes in the derived candidate mode list is to be used as the intra prediction mode for the current block based on the received index information. For example, the video decoder may receive a set MPM flag and a truncated unary code of 10, indicating index position 1 of the MPM sub-list, and determine that the intra prediction mode for the current block is the intra prediction mode positioned and index position 1 of the derived MPM sub-list.

At 1208, the video decoder performs intra prediction on the current block to generate a predicted block that corresponds to the current block based on the determined intra prediction mode for the current block.

FIG. 13 illustrates a flow diagram of a method 1300 of operating a video decoder to derive at least a portion of a candidate intra prediction mode list for a current block. The method 1300 may be performed by the video decoder devices 300 and 500 discussed above, for example.

At 1302, the video decoder determines whether each intra prediction mode for a plurality of neighboring blocks is one of a plurality of possible candidate intra prediction modes for the current block. The plurality of possible candidate intra prediction modes may be dependent on a size of the current block. As discussed above, the video decoder may determine whether intra prediction modes for larger blocks are possible intra prediction modes for a smaller current block.

At 1304, the video decoder ignores any intra prediction modes for the plurality of neighboring blocks that are not one of the possible candidate modes for the current block.

At 1306, for each of the intra prediction modes determined to be a possible candidate mode for the current block, if any, the video decoder assigns the intra prediction mode to an index position in the candidate mode list according to an order determined by the respective position of each of the plurality of neighboring blocks relative to the current block.

At 1308, the video encoder assigns one or more remaining candidate modes to respective ones of the unassigned index positions of the candidate mode list according to a determined order (e.g., ascending order, omitting previously used intra prediction codes or intra prediction codes that are not possible intra prediction codes for the current block).

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A video decoding method, comprising:
receiving, by a video decoder, index information indicating an intra prediction mode to be used as an intra prediction mode of a current block;
deriving, by the video decoder, at least a portion of a candidate mode list that includes one or more candidate intra prediction modes for the current block, wherein deriving the candidate mode list includes:
determining whether each intra prediction mode for a plurality of neighboring blocks is one of a plurality of possible candidate intra prediction modes for the current block, the plurality of possible candidate intra prediction modes being dependent on a size of the current block;
ignoring any intra prediction modes for the plurality of neighboring blocks that are not one of the possible candidate modes for the current block;
for each of the intra prediction modes determined to be a possible candidate mode for the current block, if any, assigning the intra prediction mode to an index position in the candidate mode list according to an order determined by the respective position of each of the plurality of neighboring blocks relative to the current block; and
assigning one or more remaining candidate modes to respective ones of the unassigned index positions of the candidate mode list according to a determined order;
determining, by the video decoder, which one of the candidate modes in the derived candidate mode list is to be used as the intra prediction mode for the current block based on the received index information; and
performing, by the video decoder, intra prediction on the current block to generate a predicted block that corresponds to the current block based on the determined intra prediction mode for the current block.

2. The video decoding method of claim 1 wherein receiving index information comprises receiving MPM flag information and at least one of MPM index information or remaining mode information.

3. The video decoding method of claim 2 wherein receiving index information comprises receiving a one bit MPM flag and at least one of MPM index information that comprises one or two bits or remaining mode information that comprises five or six bits.

4. The video decoding method of claim 1 wherein the candidate mode list comprises a most probable mode (MPM) sub-list and a non-MPM sub-list, the MPM sub-list comprising candidate intra prediction modes positioned at index positions 0 to 2 of the candidate mode list, and the non-MPM sub-list comprising candidate intra prediction modes positioned at index positions 3 to N−1 of the candidate mode list, wherein N is the number of possible candidate modes for the current block, and wherein receiving index information comprises receiving an MPM flag that indicates whether the candidate intra prediction mode is in the MPM sub-list or not.

5. The video decoding method of claim 4 wherein receiving index information comprises receiving a truncated unary code that specifies an index position in the MPM sub-list.

6. The video decoding method of claim 1 wherein determining whether each intra prediction mode for a plurality of neighboring blocks is one of the possible candidate modes for the current block comprises determining whether each intra prediction mode for three neighboring blocks is one of the possible candidate modes for the current block.

7. The video decoding method of claim 6 wherein the three neighboring blocks comprise neighboring blocks that are each adjacent a top-left pixel of the current block.

8. The video decoding method of claim 1 wherein the current block includes a first number of possible intra prediction modes, and at least one neighboring block includes a second number of possible intra prediction modes, the second number larger than the first number.

9. The video decoding method of claim 1 wherein, if the current block has a size that is less than N×N pixels, the current block has a first number of possible intra prediction modes that is less than a second number of possible intra prediction modes for blocks that have a size that is greater than or equal to N×N pixels.

10. The video decoding method of claim 9 wherein N is equal to 16.

11. The video decoding method of claim 1 wherein assigning one or more remaining candidate modes the unassigned index positions of the candidate mode list according to a determined order comprises assigning one or more remaining candidate modes the unassigned index positions of the candidate mode list in an ascending order.

12. The video decoding method of claim 1 wherein the possible intra prediction modes for blocks in a first size range includes 35 intra prediction modes, and the possible intra prediction modes for blocks in a second size range include 67 intra prediction modes.

13. The video decoding method of claim 12 wherein the 35 intra prediction modes comprise a DC mode, a planar mode, and 33 directional modes, and the 67 intra prediction modes comprise a DC mode, a planar mode, and 67 directional modes.

14. A video decoder, comprising:
at least one nontransitory processor-readable storage medium that stores at least one of processor-executable instructions or data; and
control circuitry communicatively coupled to the at least one nontransitory processor-readable storage medium, in operation, the control circuitry:
receives index information indicating an intra prediction mode to be used as an intra prediction mode of a current block;
derives at least a portion of a candidate mode list that includes one or more candidate intra prediction modes for the current block, wherein deriving the candidate mode list includes:
determines whether each intra prediction mode for a plurality of neighboring blocks is one of a plurality of possible candidate intra prediction modes for the current block, the plurality of possible candidate intra prediction modes being dependent on a size of the current block;
for each of the intra prediction modes determined to be a possible candidate mode for the current block, if any, assigns the intra prediction mode to an index position in the candidate mode list according to an order determined by the respective position of each of the plurality of neighboring blocks relative to the current block; and
assigns one or more remaining candidate modes to respective ones of the unassigned index positions of the candidate mode list according to a determined order;
determines which one of the candidate modes in the derived candidate mode list is to be used as the intra prediction mode for the current block based on the received index information; and
performs intra prediction on the current block to generate a predicted block that corresponds to the current block based on the determined intra prediction mode for the current block.

15. The video decoder of claim 14 wherein the candidate mode list comprises a most probable mode (MPM) sub-list and a non-MPM sub-list, the MPM sub-list comprising candidate intra prediction modes positioned at index positions 0 to 2 of the candidate mode list, and the non-MPM sub-list comprising candidate intra prediction modes positioned at index positions 3 to N−1 of the candidate mode list, wherein N is the number of possible candidate modes for the current block, and wherein the control circuitry receives an MPM flag that indicates whether the candidate intra prediction mode is in the MPM sub-list or not.

16. The video decoder of claim 15 wherein the index information includes a truncated unary code that specifies an index position in the MPM sub-list.

17. The video decoder of claim 14 wherein the plurality of neighboring blocks comprises three neighboring blocks.

18. The video decoder of claim 17 wherein the three neighboring blocks comprise neighboring blocks that are each adjacent a top-left pixel of the current block.

19. The video decoder of claim 14 wherein the current block includes a first number of possible intra prediction modes, and at least one neighboring block includes a second number of possible intra prediction modes, the second number larger than the first number.

20. A video encoding method, comprising:
receiving, by an encoder, an intra prediction mode to be used as the intra prediction mode of a current block;
determining, by the video encoder, index information indicating the intra prediction mode, wherein determining index information includes:
deriving, by the video encoder, at least a portion of a candidate mode list that includes one or more candidate intra prediction modes for the current block, wherein deriving the candidate mode list includes:
determining whether each intra prediction mode for a plurality of neighboring blocks is one of a plurality of possible candidate intra prediction modes for the current block, the plurality of possible candidate intra prediction modes being dependent on a size of the current block;
ignoring any intra prediction modes for the plurality of neighboring blocks that are not one of the possible candidate modes for the current block;
for each of the intra prediction modes determined to be a possible candidate mode for the current block, if any, assigning the intra prediction mode to an index position in the candidate mode list according to an order determined by the respective position of each of the plurality of neighboring blocks relative to the current block;
assigning one or more remaining candidate modes to respective ones of the unassigned index positions of the candidate mode list according to a determined order; and
determining, by the video encoder, the index position of the one of the candidate modes in the derived candidate mode list that is equal to the received intra prediction mode for the current block.
